(19) United States
(12) Patent Application Publication
(10) Pub. No.: US 2020/0320441 A1
(43) Pub. Date: Oct. 8, 2020

(54) CLASSROOM VACANCY DETERMINATION FOR BROKERED TUTOR MATCHING

(71) Applicant: TEDU, LLC, Miami, FL (US)

(72) Inventors: James Nicolo Bates, Miami, FL (US); Dmitry Osetrov, Miami, FL (US)

(21) Appl. No.: 16/374,637

(22) Filed: Apr. 3, 2019

(51) Int. Cl. G06Q 10/02; G06F 16/9537; G06Q 10/10; G09B 5/14

(52) U.S. Cl. CPC G06Q 10/02; G09B 5/14; G06Q 10/1095; G06F 16/9537

(57) ABSTRACT

A method for classroom vacancy determination in brokered tutor matching includes receiving a request for tutoring services from a student for a specified course and matching the request to a tutor able to tutor in the specified one of the courses. The method yet further includes retrieving a manifest of classrooms for the academic institution and also a class schedule for classes at the academic institution at a time of the proposed tutoring, and determining from the class schedule, each classroom in the manifest assigned to one of the classes scheduled at the time of tutoring so as to generate a list of the classrooms not assigned to any of the classes scheduled at the time of tutoring. Finally, the method includes selecting a classroom from at least a subset of the list as a venue for the tutoring services.

### BACKGROUND OF THE INVENTION

### Field of the Invention

The present invention relates to the field of on-line scheduling and more particularly to the coordination of a student tutoring session.

### Description of the Related Art

The process of classroom education refers to the attendance by a student in a class instructed by a teacher within a classroom environment at an educational institution. Traditional classroom education involves the delivery of one or more classroom lectures, roundtable discussions or laboratories on a fixed schedule according to a syllabus with one or more graded examinations administered throughout. In so far as the material instructed during a classroom session may be of such density so as to required additional instruction, in many instances, additional private sessions with the instructor may be attended by a student in the form of “office hours”. As well, to the extent that the office hours are not sufficient to service the instructional needs of all students, for many courses, teaching assistants are enlisted to provide additional instruction also in the form of office hours, or alternatively in a group attended additionally scheduled class.

Despite opportunities afforded by classroom instruction and office hours in the academic session, oftentimes, for many students, more personalized attention is required. To that end, in most academic environments, private and small-group tutoring services may be offered, either as an offering of the academic institution, an offering that is separate from but coordinated by the academic institution, or as a third party offering without coordination with the academic institution. In the former instance, the academic institution may allocate space in the physical plant of the campus and hire or contract one or more tutors to be present during certain defined hours within the physical plant. In the latter circumstance, individual, enterprising students may advertise available tutoring services through campus media, printed flyers, online advertising, or by word of mouth. Notwithstanding, the manner in which tutoring services are offered, whether by the academic institution or privately by a third party, is not without its drawbacks.

In this regard, as an initial matter, the need for a tutor oftentimes arises suddenly and, in many instances, in reference to an impending examination. Yet the rigid hours of a university tutoring center may not accommodate the urgent and timely needs of such students. As well, for private, third party tutors, locating a suitable venue for conducting the tutoring session requires a manual negotiation between student and third-party tutor and can be quite tedious—particularly since it is unknown generally to both parties whether or not a suitable venue is vacant and thus can support the proposed tutoring session at the proposed time for the proposed duration. Thus, the student in need of tutoring must not only struggle in locating a suitable tutor for the subject matter at hand, but also the student in need of tutoring must also locate a suitable venue at which to conduct the tutoring session.

### BRIEF SUMMARY OF THE INVENTION

Embodiments of the present invention address deficiencies of the art in respect to scheduling of tutoring for students in an academic environment and provide a novel and non-obvious method, system and computer program product for classroom vacancy determination in brokered tutor matching. In an embodiment of the invention, a method for classroom vacancy determination in brokered tutor matching includes first receiving, from over a computer communications network in memory of a host computer, a tutoring request for tutoring services for a student registered for a selection of courses at an academic institution, that specifies one of the courses, a time of tutoring and duration of tutoring. Then, the tutoring request is matched to a tutor registered in the host computer to perform tutoring in the specified one of the courses.

Once the tutoring request has been matched to the tutor, the method yet further includes retrieving from fixed storage, a manifest of classrooms for the academic institution and also a class schedule for classes at the academic institution at the time of tutoring. As such, it can be determined from the class schedule, each of the classrooms in the manifest assigned to one of the classes scheduled at the time of tutoring. Consequently, a list may be generated of the classrooms in the manifest not assigned to any of the classes scheduled at the time of tutoring. Finally, the method includes presenting at least a subset of the list in a user interface of a mobile device of at least one of the student and tutor for selection as a venue for the tutoring services at the time of tutoring and selecting in the user interface, one of the classrooms in the list as the selected venue for the tutoring services at the time of tutoring.

In one aspect of the embodiment, the method additionally includes geo-locating each mobile device of the student and tutor, and including in the list only ones of the classrooms located between the geo-location of each mobile device. However, in another aspect of the embodiment, in the event that the list includes no classrooms because it is determined that none of the classrooms in the list are located between the geo-location of each mobile device, the method additionally includes adding to the list a classroom determined to be closest to a geo-location of the student, or oppositely, that of the tutor.

Yet further, in the event that the list includes no classrooms because it is determined that none of the classrooms in the list are located between the geo-location of each mobile device, the method alternatively includes retrieving a list of sponsored public spaces geo-located in proximity to the academic institution and adding to the list the sponsored public spaces each with a corresponding symbol encapsulating a promotional offering. Finally, in the event that the list includes no classrooms because it is determined that none of the classrooms in the list are located between the geo-location of each mobile device, the method includes, as yet another alternative, retrieving a list of libraries located on campus of the academic institution and adding to the list one of the libraries determined to be closest to a geo-location of the student.

In another embodiment of the invention, a data processing system is configured for classroom vacancy determination in brokered tutor matching. The system includes a host computing system including one or more computing servers, each with memory and at least one processor. The system also includes a multiplicity of communicative links with a corresponding multiplicity of remote computing devices over a computer communications network and a database coupled to the host computing system which includes a multiplicity of records, each corresponding to a different student, each of the records including a course listing of courses for which the different student is registered at an academic institution, a demographic profile of the different student and an indication of a number of credits available for use by the different student in procuring tutoring services. The database further includes a registry of different tutors able to provide tutoring services in connection with different academic topics.

Of note, a tutor matching module is provided. The tutor matching module executes in memory of the host computing system and includes computer program instructions enabled during execution in the host computing system to receive a request for tutoring from over the computer communications network, the request identifying a particular student registered for academic studies at an academic institution and in respect to a specific academic topic for a specified duration at a specified time, and to match the request to a selected one of the tutors to perform the tutoring services as requested by the particular student. As well, a classroom vacancy determination module is provided and coupled to the tutor matching module.

The classroom vacancy determination module includes computer program instructions enabled during execution in the host computing system to retrieve from fixed storage, a manifest of classrooms for the academic institution and also a class schedule for classes at the academic institution at the time of tutoring, to determine from the class schedule, each of the classrooms in the manifest assigned to one of the classes scheduled at the time of tutoring and generate a list of the classrooms in the manifest not assigned to any of the classes scheduled at the time of tutoring, to present at least a subset of the list in a user interface of a mobile device of at least one of the student and tutor for selection as a venue for the tutoring services at the time of tutoring and to select in the user interface, one of the classrooms in the list as the selected venue for the tutoring services at the time of tutoring.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for classroom vacancy determination for brokered tutor matching;

FIG. 2 is a data processing system configured for classroom vacancy determination for brokered tutor matching; and,

FIG. 3 is a flow chart illustrating a process for classroom vacancy determination for brokered tutor matching.

### DETAILED DESCRIPTION OF THE INVENTION

Embodiments of the invention provide for classroom vacancy determination for brokered tutor matching. In accordance with an embodiment of the invention, a tutoring match is determined in a tutor matching server between a student seeking tutoring services for a specific academic topic at a particular time for a particular duration, and a tutor able to provide the tutoring services for the specific academic topic at the particular time for the particular duration. A manifest of classrooms for the academic institution are retrieved from the academic institution and a list of classrooms not assigned to a class at a time corresponding to the particular time of the tutoring services is assembled. Then, a geo-location for each of the student and tutor is ascertained and a classroom in the list with a location disposed between a geo-location of the tutor and a geo-location of the tutor is selected as a venue for the tutoring services.

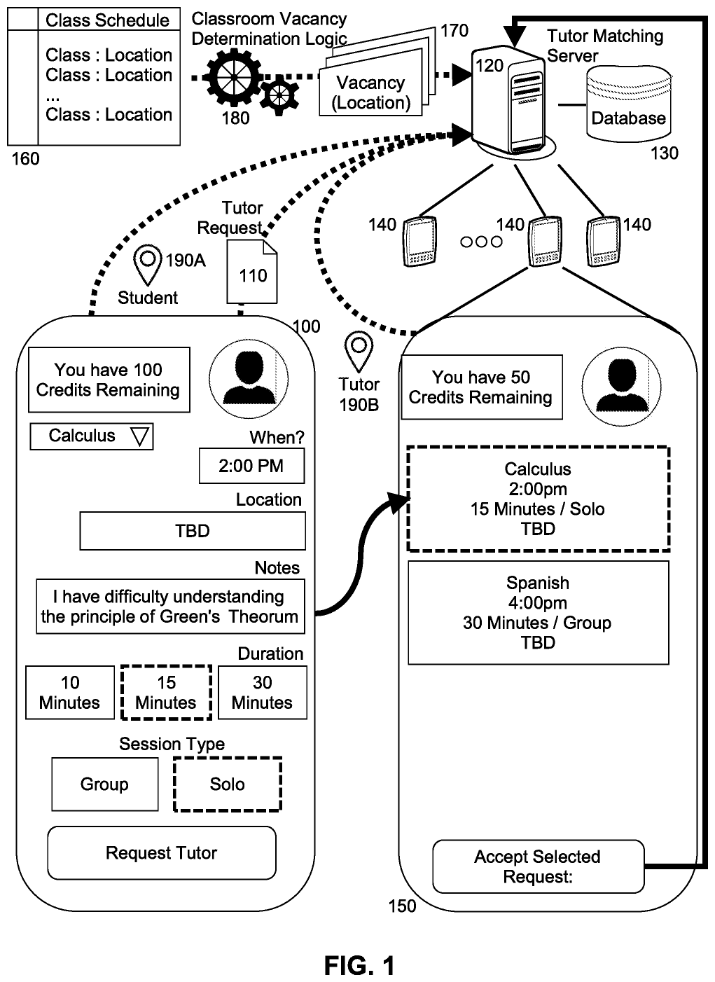

In further illustration, FIG. 1 pictorially shows a process for classroom vacancy determination for brokered tutor matching. As shown in FIG. 1, a student through user interface 100 to a tutor matching server 120 formulates a request 110 for tutoring services. The request 110 is formulated through the interaction by the student with different user interface controls of the user interface 100. In particular, and as a non-limiting example, FIG. 1 shows a user interface 100 including controls presenting a selectable list of courses for which the student has been contemporaneously registered and for which tutoring is requested, an input field into which a time for the tutoring session may be specified, a free-form text input field into which additional comments regarding the required tutoring services may be provided, a selection of tutoring session durations, a selection of tutoring session types, and a submit button responsive to which a tutor request 110 including the information provided in the user interface 100 is transmitted over a computer communications network to the tutor matching server 120.

The tutor matching server 120, upon receiving the tutor request 110 generates a request for tutoring for broadcasting to the mobile computing devices 140 of only those tutors registered in the database 130 known to have a proficiency in tutoring students in the topic specified by the tutor request 110. Each of the selected tutors receiving the broadcast request viewed the content of the broadcast request in a corresponding user interface 150. The user interface 150 of each corresponding one of the recipient tutors provides a listing of all tutoring requests broadcast to the corresponding one of the recipient tutors that has yet to be assigned to a particular one of the recipient tutors. Each entry in the listing is selectable and provides the pertinent details of the tutoring request such as the subject matter for which tutoring session is required, a time of occurrence of the tutoring session, and a duration of the tutoring session. The user interface 150 additionally includes an activatable submit button submitting the election by the corresponding one of the tutors to perform the requested tutoring services for the selected request in the listing. The tutor matching server 120 then assigns a tutor to the student on a first-come first-serve basis meaning the first of the tutors accepting the broadcast request automatically is assigned to the student for tutoring.

Once a tutor has been assigned to the student for the tutoring session, classroom vacancy determination logic 180 accesses a manifest 160 for all courses offered at the academic institution and determines a time of offering of each of the courses. The classroom vacancy determination logic 180 then filters the manifest 160 to produce a list 170 of only those classrooms in the manifest 160 not assigned to a class during the time of occurrence of the tutoring session and further not previously assigned as a venue for a different tutoring session during the time of occurrence. Once the list 170 has been produced, the classroom vacancy determination logic 180 identifies a location 190A of the student, and a location 190B of the tutor. Thereafter, the classroom vacancy determination logic 170 identifies a location of each of the classrooms in the list 170 and selects one of the classrooms having a location that is disposed between the location 190A of the student, and the location 190B of the tutor as the location of the tutoring session.

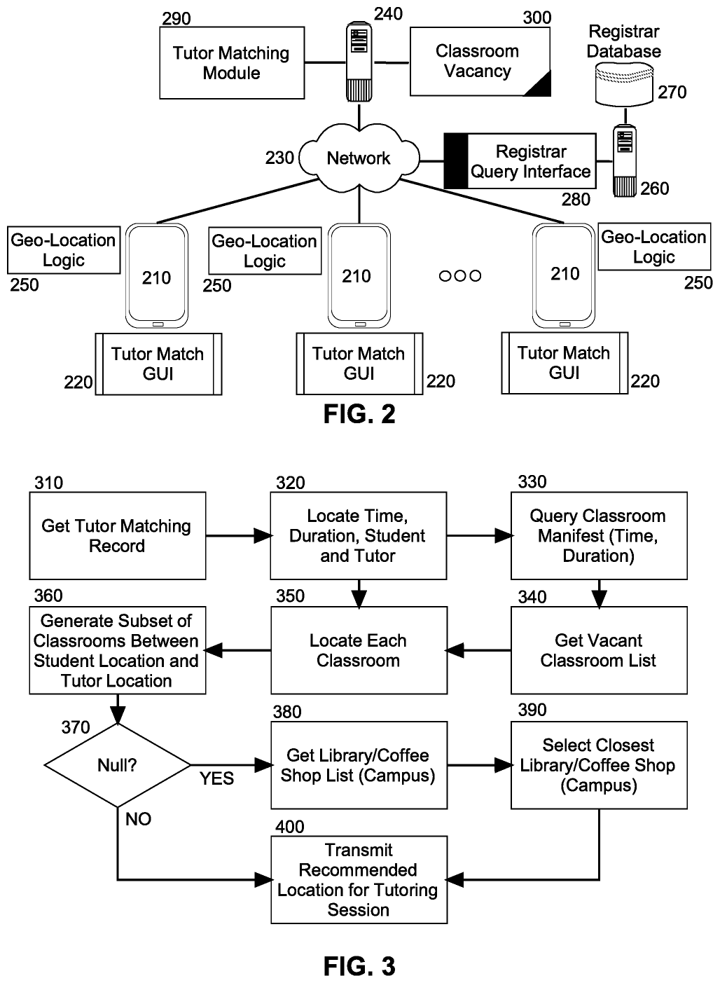

The process described in connection with FIG. 1 may be implemented within a computer data processing system. In further illustration, FIG. 2 is schematic illustration depicting a data processing system configured for classroom vacancy determination for brokered tutor matching. The system includes a host computing server 240 including one or more computers, each with memory and at least one processor. The host computing server 240 is communicatively linked to different mobile devices 210 over computer communications network 230, each of the mobile devices 210 belonging either to a student in an academic institution, a tutor at the academic institution, or both.

The host computing server 240 includes a database 250 that may include one or more databases either locally present within the host computing server 240, or accessible remotely by the host computing server 240. The database 250 includes a tutor registry and a student table. The tutor registry includes a listing of different tutors registered to perform tutoring services in connection with one or more academic topics at a specified intensity level. The student table includes a listing of different students registered to receive tutoring services. Optionally, the student table includes for each corresponding student, a set of courses for which the corresponding student is contemporaneously registered at the academic institution.

Importantly, a tutor matching module 290 executes in the memory of the host computing server 240. The tutor matching module 290 includes computer program instructions that during execution, receive through a tutor matching user interface 220 in a mobile device 210 of a tutor request for tutoring services in a specified academic topic of interest at a particular time and location for a specified duration of time, and compute from the tutor request, a requisite intensity of tutoring. The program instructions during execution additionally locate within the tutor registry, a selection of tutors able to perform the requested tutoring services at the computed requisite intensity of tutoring. The program instructions during execution even further broadcast to the selection of tutors, the tutor request for viewing in the user interface 220 of respective ones of the mobile devices 210 of the selection of tutors. Finally, the program instructions during execution match a first responding one of the tutors to the student issuing the request and upon completion of the tutoring session, transfer credits from the student to the tutor in accordance with a quoted rate for employing the assigned tutor for the tutoring session.

Of note, once the tutor matching module 290 has matched a tutor to the student for the requested tutoring session, classroom vacancy module 300 also including program instructions executing in the memory of the host computer server 240 accesses registrar database 270 through the query interface 280 to determine a vacancy of each classroom at the prescribed time of the tutoring session and to produce a list of vacant classrooms for the tutoring session. The program code of the classroom vacancy module 300 further determines a location of each of the classrooms in the list and compares the location to a determined location for the tutor and student as emitted from corresponding geo-location logic 250 disposed in respective ones of the mobile devices 210 of the tutor and student. Thereafter, the program code of the classroom vacancy module 300 selects one of the vacant classrooms known to have a geo-location between that of the student and tutor.

In one aspect of the embodiment, no classrooms in the list are determined to exist between the geo-location of the student and the geo-location of the tutor. In that instance, one of the classrooms in the list nearest to the course for which tutoring is sought is selected. Alternatively, a classroom in the list closest to either the student or tutor is selected as the venue for the tutoring session. In yet another alternative, a library on campus of the academic institution is selected as the venue for the tutoring session. Finally, in even yet another alternative, the program code of the classroom vacancy module 300 selects a sponsored public space proximate to the campus as the venue for the tutoring session. In this regard, a listing of public spaces proximate to the campus, for instance a coffee shop or campus food court, may be presented in the list in association with respective promotional offerings such as a discounted price on the purchase of a product. The promotional offerings may be encapsulated in a symbol such as a bar code or quick response code.

In even yet further illustration of the operation of the classroom vacancy module 300, FIG. 3 is a flow chart illustrating a process for classroom vacancy determination for brokered tutor matching. Beginning in block 310, a tutor matching record for a tutoring session is retrieved into memory and in block 320, a time, duration, student and tutor are identified for the tutoring session. In block 330, a classroom manifest is queried with the time and duration in order to determine a list of vacant classrooms at the time of the proposed tutoring session in block 340. In block 350, a geo-location is ascertained for each of the classrooms determined to be vacant and in block 360, a subset of the list is generated to include only ones of the classrooms in the list having a geo-location disposed between a geo-location of the student, and a geo-location of the tutor.

In decision block 370, it is determined if the subset includes a null set—e.g. no classrooms present in the subset. If not, in block 400 one of the classrooms in the subset most equidistant from the geo-location of the tutor and the geo-location of the student is selected as the venue for the tutoring session and the selection is transmitted to a mobile device of each of the student and tutor. But, otherwise, in block 380 as an alternative to a classroom, a list of library and coffee shop locations proximate to the academic institution are retrieved and in block 390, a closest one of the library and coffee shop locations to a path between the tutor and student is selected as the venue for the tutoring session and in block 400, the selection is transmitted to the mobile device of each of the student and tutor.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for classroom vacancy determination in brokered tutor matching, the method comprising:
receiving from over a computer communications network in memory of a host computer, a tutoring request for tutoring services from a student registered for a selection of courses at an academic institution, the request specifying one of the courses, a time of tutoring and duration of tutoring;
matching the tutoring request to a tutor registered in the host computer to perform tutoring in the specified one of the courses;
retrieving from fixed storage, a manifest of classrooms for the academic institution and also a class schedule for classes at the academic institution at the time of tutoring;
determining from the class schedule, each of the classrooms in the manifest assigned to one of the classes scheduled at the time of tutoring and generating a list of the classrooms in the manifest not assigned to any of the classes scheduled at the time of tutoring;
presenting at least a subset of the list in a user interface of a mobile device of at least one of the student and tutor for selection as a venue for the tutoring services at the time of tutoring; and,
selecting in the user interface, one of the classrooms in the list as the selected venue for the tutoring services at the time of tutoring.

2. The method of claim 1, further comprising:
geo-locating each mobile device of the student and tutor; and,
including in the list only ones of the classrooms located between the geo-location of each mobile device.

3. The method of claim 2, further comprising, on condition that the list includes no classrooms because it is determined that none of the classrooms in the list are located between the geo-location of each mobile device, adding to the list a classroom determined to be closest to a geo-location of the student.

4. The method of claim 2, further comprising, on condition that the list includes no classrooms because it is determined that none of the classrooms in the list are located between the geo-location of each mobile device, adding to the list a classroom determined to be closest to a geo-location of the tutor.

5. The method of claim 2, further comprising, on condition that the list includes no classrooms because it is determined that none of the classrooms in the list are located between the geo-location of each mobile device, retrieving a list of sponsored public spaces geo-located in proximity to the academic institution and adding to the list the sponsored public spaces each with a corresponding symbol encapsulating a promotional offering.

6. The method of claim 2, further comprising, on condition that the list includes no classrooms because it is determined that none of the classrooms in the list are located between the geo-location of each mobile device, retrieving a list of libraries located on campus of the academic institution and adding to the list one of the libraries determined to be closest to a geo-location of the student.

7. A data processing system configured for classroom vacancy determination in brokered tutor matching, the system comprising:
a host computing system comprising one or more computing servers, each with memory and at least one processor, the system comprising a multiplicity of communicative links with a corresponding multiplicity of remote computing devices over a computer communications network;
a database coupled to the host computing system, the database comprising a multiplicity of records, each corresponding to a different student, each of the records comprising a course listing of courses for which the different student is registered at an academic institution, a demographic profile of the different student and an indication of a number of credits available for use by the different student in procuring tutoring services, the database further comprising a registry of different tutors able to provide tutoring services in connection with different academic topics;
a tutor matching module executing in memory of the host computing system, the module comprising computer program instructions enabled during execution in the host computing system to receive a request for tutoring from over the computer communications network, the request identifying a particular student registered for academic studies at an academic institution and in respect to a specific academic topic for a specified duration at a specified time and matching the request to a selected one of the tutors to perform the tutoring services as requested by the particular student; and,
a classroom vacancy determination module coupled to the tutor matching module, the classroom vacancy determination module comprising computer program instructions enabled during execution in the host computing system to perform:
retrieving from fixed storage, a manifest of classrooms for the academic institution and also a class schedule for classes at the academic institution at the time of tutoring;
determining from the class schedule, each of the classrooms in the manifest assigned to one of the classes scheduled at the time of tutoring and generating a list of the classrooms in the manifest not assigned to any of the classes scheduled at the time of tutoring;
presenting at least a subset of the list in a user interface of a mobile device of at least one of the student and tutor for selection as a venue for the tutoring services at the time of tutoring; and,
selecting in the user interface, one of the classrooms in the list as the selected venue for the tutoring services at the time of tutoring.

8. The system of claim 7, wherein the program instructions of the classroom vacancy determination module during execution are further enabled to perform:
geo-locating each mobile device of the student and tutor; and,
including in the list only ones of the classrooms located between the geo-location of each mobile device.

9. The system of claim 8, wherein the program instructions of the classroom vacancy determination module during execution are further enabled to perform, on condition that the list includes no classrooms because it is determined that none of the classrooms in the list are located between the geo-location of each mobile device, adding to the list a classroom determined to be closest to a geo-location of the student.

10. The system of claim 8, wherein the program instructions of the classroom vacancy determination module during execution are further enabled to perform, on condition that the list includes no classrooms because it is determined that none of the classrooms in the list are located between the geo-location of each mobile device, adding to the list a classroom determined to be closest to a geo-location of the tutor.

11. The system of claim 8, wherein the program instructions of the classroom vacancy determination module during execution are further enabled to perform, on condition that the list includes no classrooms because it is determined that none of the classrooms in the list are located between the geo-location of each mobile device, retrieving a list of sponsored public spaces geo-located in proximity to the academic institution and adding to the list the sponsored public spaces each with a corresponding symbol encapsulating a promotional offering.

12. The system of claim 8, wherein the program instructions of the classroom vacancy determination module during execution are further enabled to perform, on condition that the list includes no classrooms because it is determined that none of the classrooms in the list are located between the geo-location of each mobile device, retrieving a list of libraries located on campus of the academic institution and adding to the list one of the libraries determined to be closest to a geo-location of the student.

13. A computer program product for classroom vacancy determination in brokered tutor matching, the computer program product including a computer readable storage medium having program instructions embodied therewith, the program instructions executable by a device to cause the device to perform a method including:
receiving from over a computer communications network in memory of a host computer, a tutoring request for tutoring services for a student registered for a selection of courses at an academic institution, the request specifying one of the courses, a time of tutoring and duration of tutoring;
matching the tutoring request to a tutor registered in the host computer to perform tutoring in the specified one of the courses;
retrieving from fixed storage, a manifest of classrooms for the academic institution and also a class schedule for classes at the academic institution at the time of tutoring;
determining from the class schedule, each of the classrooms in the manifest assigned to one of the classes scheduled at the time of tutoring and generating a list of the classrooms in the manifest not assigned to any of the classes scheduled at the time of tutoring;
presenting at least a subset of the list in a user interface of a mobile device of at least one of the student and tutor for selection as a venue for the tutoring services at the time of tutoring; and,
selecting in the user interface, one of the classrooms in the list as the selected venue for the tutoring services at the time of tutoring.

14. The computer program product of claim 13, wherein the method further comprises:
geo-locating each mobile device of the student and tutor; and,
including in the list only ones of the classrooms located between the geo-location of each mobile device.

15. The computer program product of claim 14, wherein the method further comprises, on condition that the list includes no classrooms because it is determined that none of the classrooms in the list are located between the geo-location of each mobile device, adding to the list a classroom determined to be closest to a geo-location of the student.

16. The computer program product of claim 14, wherein the method further comprises, on condition that the list includes no classrooms because it is determined that none of the classrooms in the list are located between the geo-location of each mobile device, adding to the list a classroom determined to be closest to a geo-location of the tutor.

17. The computer program product of claim 14, wherein the method further comprises, on condition that the list includes no classrooms because it is determined that none of the classrooms in the list are located between the geo-location of each mobile device, retrieving a list of sponsored public spaces geo-located in proximity to the academic institution and adding to the list the sponsored public spaces each with a corresponding symbol encapsulating a promotional offering.

18. The computer program product of claim 14, wherein the method further comprises, on condition that the list includes no classrooms because it is determined that none of the classrooms in the list are located between the geo-location of each mobile device, retrieving a list of libraries located on campus of the academic institution and adding to the list one of the libraries determined to be closest to a geo-location of the student.
